(19) United States
(12) Patent Application Publication
(10) Pub. No.: US 2002/0112572 A1
(43) Pub. Date: Aug. 22, 2002

(54) Hammer head with trampoline plate

(76) Inventor: Gary Pimentel, San Marcos, CA (US)

Correspondence Address: Ross Patent Law Office, P.O. Box 2138, Del Mar, CA, 92014, US

(21) Appl. No.: 09/905,081

(22) Filed: Jul. 13, 2001

Related U.S. Application Data
(63) Continuation-in-part of application No. 09/790,431, filed on Feb. 21, 2001.

(51) Int. Cl. B25D 1/00

(52) U.S. Cl. 81/20

(57) ABSTRACT

A striking tool having a handle and a head attached to the handle. The head defines a front end and a back end. A trampoline plate is attached to the head at the front end. The trampoline plate deflects inward toward the back end and rebounds in a direction away from the back end when the trampoline plate strikes an object. In a preferred embodiment, the striking tool is a hammer and the handle is fabricated by welding together matching molded sheet aluminum handle halves. A receiving nut is welded at a top end of the handle and a hammer head is attached to the handle with a bolt threaded through the receiving nut. In this embodiment the aluminum sheet is only approximately 0.063 inches thick so the hammer handle is very light. A rigid rib that extends through the hollow portion of the hollow handle provides additional strength.

This application is a continuation-in-part application of Serial No. 09/790,431 filed Feb. 2, 2001.

The present invention relates to striking tools, and in particular to heads for striking tools.

### BACKGROUND OF THE INVENTION

### Prior Art Hammers

Striking tools are extremely well known. Prehistoric man knew how to use a club as a tool and as a weapon. As technology developed, the sophistication of striking tools also developed. The hammer was eventually invented and is very common in modem society. Hammers are found in a majority of households in developed countries and are also commonly used by construction companies. However, hammer technology has not changed much since they were invented many centuries ago. Most hammers utilized today, as in the past, have wooden handles and solid steel hammer heads. Wooden handles tend to resonate when in use. The resultant vibration can be fatiguing to the user. Also, solid steel heads tend to be heavy and can cause fatigue to the user after repeated usage.

### Monocoque Structure

A monocoque structure is one in which the skin absorbs all or most of the stresses to which the structure is subjected. Because the skin absorbs all or most of the stresses, a monocoque structure can be strong as well as lightweight. Recently, for example, aluminum lightweight monocoque bicycle frames have become very popular for mountain bikes because they provide a strong and stiff, yet lightweight structure.

### Trampoline Effect

The trampoline effect (also known as “spring-like effect”) is a term that has recently been applied to certain types of golf club heads. A golf club head that utilizes the trampoline effect has a face plate that deforms when the plate strikes the ball. Behaving like a spring, the face plate rebounds to give the ball a higher launch velocity. For example, FIG. 27 shows club head 400 moving towards golf ball 402. Club head 400 has hollow chamber 404 covered by thin face plate 406. FIG. 28 shows club 400 after it has impacted golf ball 402. The collision between ball 402 and club 400 has caused face plate 406 to deform inward. FIG. 29 shows ball 402 leaving club 400. Acting as a spring, face plate 406 has rebounded adding extra velocity to ball 402.

A golf club that effectively utilizes the trampoline effect can have a very high coefficient of restitution. The coefficient of restitution “e” for the club is calculated as e=vₒᵤₜ/vᵢₙ. The coefficient of restitution of a club can be calculated by holding the face plate of the club stationary. A golf ball is then launched at the face plate at velocity vᵢₙ. The golf ball then rebounds from the face plate with velocity vₒᵤₜ. It has been shown that the trampoline effect increases the launch velocity (vₒᵤₜ) of the golf ball.

Golf clubs that utilize the trampoline effect have recently been subject to close scrutiny by the U.S. Golf Association (USGA). In recognition of the added velocity achieved by the trampoline effect and in the USGA's resolve not to permit technology to overwhelm the game, the USGA has gone so far as to designate certain golf clubs that utilize the trampoline effect “illegal”. As of Jun. 25, 2001, the USGA has examined more than 1000 golf clubs to determine compliance with the spring-like effect standard and has identified 38 clubs that are non-conforming. The USGA considers a club non-conforming if it has a coefficient of restitution greater than 0.83 when impacting a golf ball at a velocity of 160 ft/sec.

What is needed is a better striking tool.

### SUMMARY OF THE INVENTION

The present invention provides a striking tool having a handle and a head attached to the handle. The head defines a front end and a back end. A trampoline plate is attached to the head at the front end. The trampoline plate deflects inward toward the back end and rebounds in a direction away from the back end when the trampoline plate strikes an object. In a preferred embodiment, the striking tool is a hammer and the handle is fabricated by welding together matching molded sheet aluminum handle halves. A receiving nut is welded at a top end of the handle and a hammer head is attached to the handle with a bolt threaded through the receiving nut. In this embodiment the aluminum sheet is only approximately 0.063 inches thick so the hammer handle is very light. A rigid rib that extends through the hollow portion of the hollow handle provides additional strength.

### BRIEF DESCRIPTION OF THE DRAWINGS

FIG. 1 shows a cut out handle side.

FIG. 2 shows a cut out rib.

FIG. 3 shows a cut out handle bottom piece.

FIG. 4 shows a sheet of aluminum with cut out pieces.

FIG. 5 shows a flat handle side mounted on a mold.

FIG. 6 shows a formed handle side mounted on a mold.

FIG. 7 shows another formed handle side mounted on a mold.

FIG. 8 shows another flat handle side mounted on a mold.

FIG. 9 shows a formed handle side mounted on a contoured trim support piece.

FIG. 10 shows aligned pieces.

FIG. 11 shows a side view of aligned pieces.

FIG. 12 shows a handle.

FIG. 13 shows a perspective view of a handle.

FIG. 14 shows a preferred embodiment of the present invention.

FIG. 15 shows a perspective view of a handle with a nut inserted.

FIG. 16 shows a perspective view of a handle with a nut welded.

FIG. 17 shows an exploded view of a preferred embodiment of the present invention.

FIG. 18 shows a top view of a preferred embodiment of the present invention.

FIG. 19 shows a side view of a preferred embodiment of the present invention.

FIG. 20 shows another preferred embodiment of the present invention.

FIG. 21 shows a top view of another preferred embodiment of the present invention.

FIG. 22 shows another preferred embodiment of the present invention.

FIG. 23A shows a threaded insert.

FIG. 23B shows another preferred embodiment of the present invention.

FIG. 24 shows a long rib.

FIG. 25 shows aligned pieces.

FIG. 26 shows a side view of the aligned pieces.

FIGS. 27-29 show a sequence illustrating the operation of a trampoline plate on a golf club head.

FIG. 30 shows a preferred hammer having a head with a trampoline plate.

FIG. 31 shows an exploded view of the head shown in FIG. 30.

FIGS. 32-34 show front views of some of the components shown in FIG. 31.

FIG. 35 shows another preferred head with trampoline plate.

FIGS. 36-40 show a sequence illustrating the operation of the preferred hammer shown in FIG. 30.

### DETAILED DESCRIPTION OF THE PREFERRED EMBODIMENTS

Preferred embodiments of the present invention are hereinafter described by reference to the drawings.

### Cutting Pieces From Aluminum Sheet

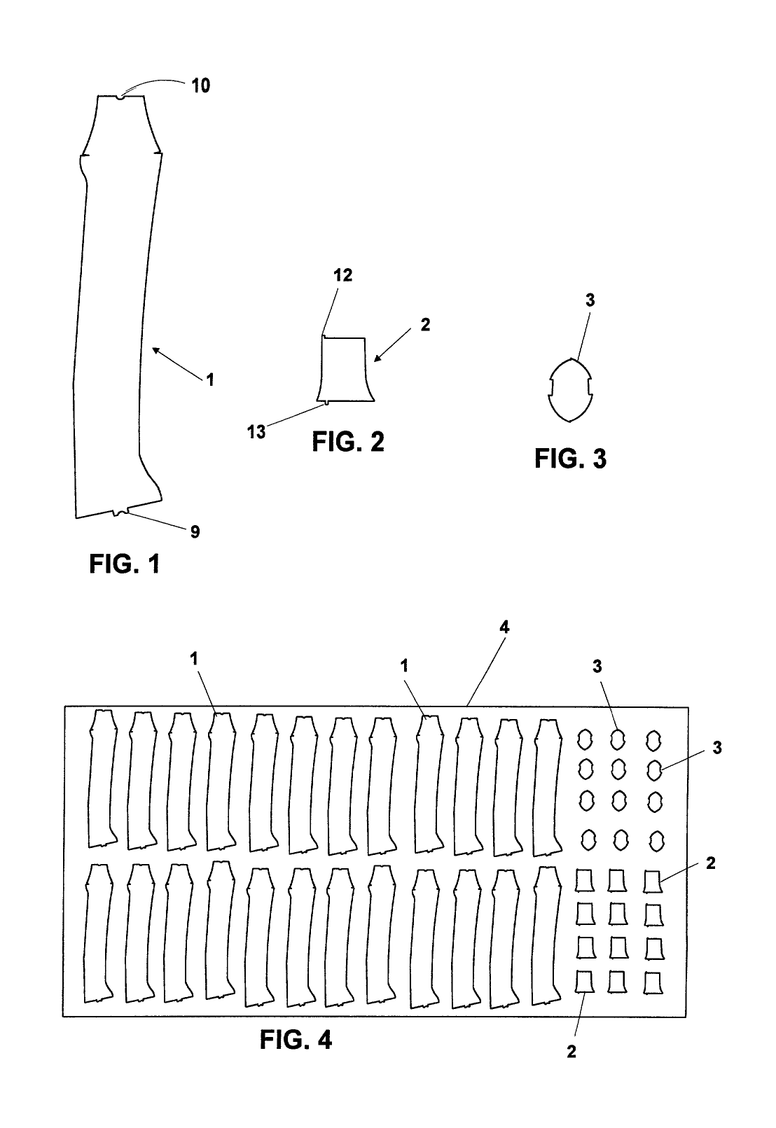

In a preferred embodiment of the present invention, flat handle sides 1, rib pieces 2, and handle bottom pieces 3 are cut from 4′×8′ sheet 4, as shown in FIG. 4. In the preferred embodiment, flat handle sides 1, rib pieces 2, and handle bottom pieces 3 are cut using a water jet saw. Preferably, sheet 4 is 6061 aluminum and is approximately 0.063 inch thick. Detailed views of flat handle side 1, rib piece 2 and handle bottom piece 3 are shown in FIGS. 1-3. In a preferred embodiment, flat handle side 1 is approximately 17 ½ inches long, rib piece 2 is approximately 2⅜ inches long and handle bottom piece 3 is approximately 2⅛ inches from top to bottom as shown in FIG. 3.

### Forming Handle Sides

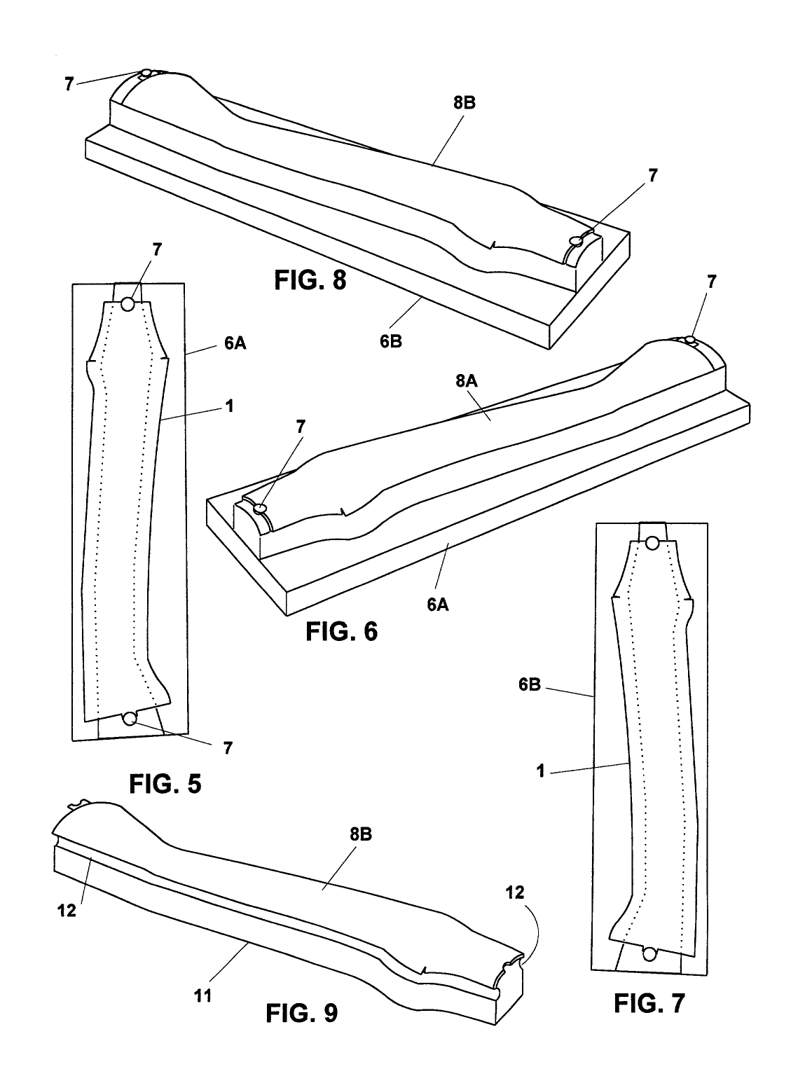

As shown in FIG. 5, flat handle side 1 is laid on contoured mold 6A. Flat handle side 1 is held in place on contoured mold 6A by nails 7 aligned against extension 9 and indentation 10 (see FIG. 1). Contoured mold 6A with flat handle side 1 is then placed inside a hydraulic ram press and approximately 40,000 psi of pressure is imparted to the top of flat handle side 1. This pressure causes flat handle side 1 to assume the contoured shape of the top of contoured mold 6A. In a preferred embodiment, the contoured shape of the top of contoured mold 6A is similar to the shape of half of a hammer handle. As shown in FIG. 6, after contoured mold 6A has been removed from the hydraulic ram press, flat handle side 1 has been formed into formed handle side 8A.

Then, a second flat handle side 1 is flipped over and laid on contoured mold 6B as shown in FIG. 7. In a fashion similar to that described above, contoured mold 6B is placed in a hydraulic ram press and so that flat handle side 1 is formed into formed handle side 8B, as shown in FIG. 8.

### Trimming Handle Edges

The edges of formed handle sides 8A and 8B may be rough due to slight imperfections during the cutting of flat handle sides 1. Therefore, in a preferred embodiment, the edges of formed handle sides 8A and 8B are trimmed so that they will fit together better. FIG. 9 shows formed handle side 8B laid on top of contoured trim support piece 11. Contoured trim support piece 11 has trough 12. To trim the edges of formed handle side 8B a router bit is set at the proper level to run along trough 12. The router bit is then run along trough 12. The router bit will cut off imperfections in the edges that extend into trough 12.

### Aligning and Joining Pieces Together

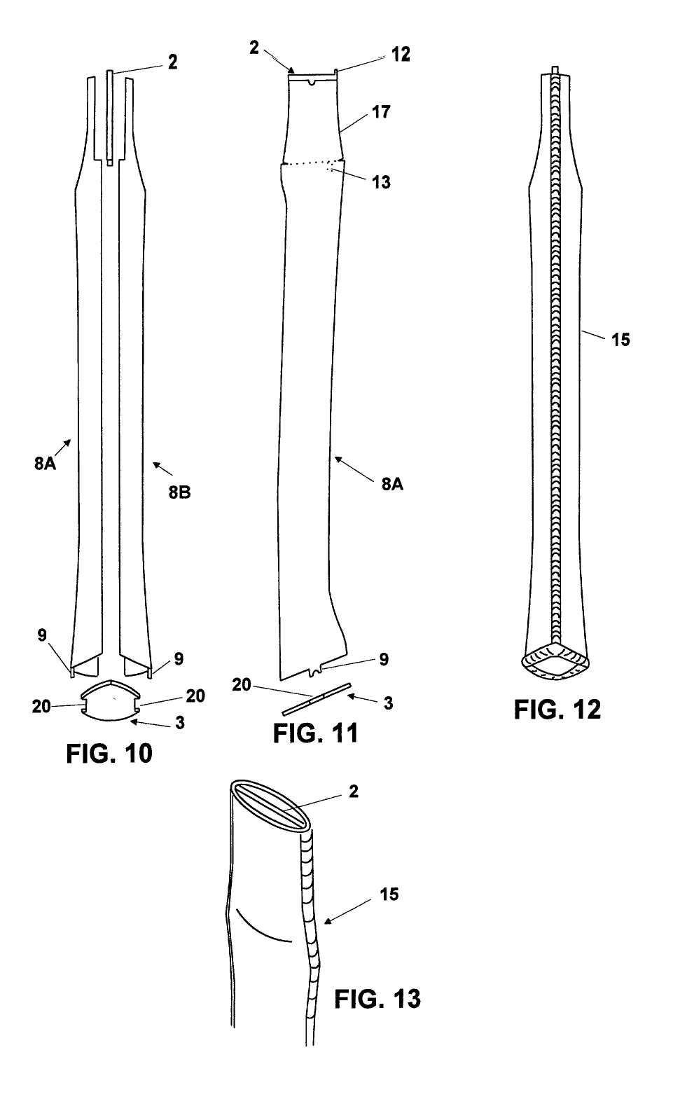

FIG. 10 shows a front exploded view and FIG. 11 shows a corresponding side view of the preferred embodiment. Formed handle sides 8A and 8B, rib piece 2 and handle bottom piece 3 are aligned as shown. In the preferred embodiment, rib piece 2 has extensions 12 and 13 (also shown in FIG. 1). Extensions 12 and 13 aid in the alignment of rib piece 2 with edge 17 of formed handle side 8A. The individual aligning rib piece 2 can look at extensions 12 and 13 to realize to realize that the side of rib piece 2 containing extensions 12 and 13 should be the side of rib piece 2 aligned with edge 17. Handle bottom piece 3 is then properly aligned with the bottom of formed handle sides 8A and 8B by aligning cut-out portions 20 with extensions 9. In the preferred embodiment, handle bottom piece 3 is also by extensions 9 when it is pressed up against the bottom of formed handle sides 8A and 8B.

After formed handle sides 8A and 8B, rib piece 2 and handle bottom piece 3 are properly aligned, they are then clamped together. They are then tacked and welded together so that they form monocoque handle 15 as shown in FIG. 12. In the preferred embodiment, the top of monocoque handle 15 is cut so that it is flat as shown in FIG. 13.

### Attaching the Hammer Head to the Handle Bolting the Head to the Handle

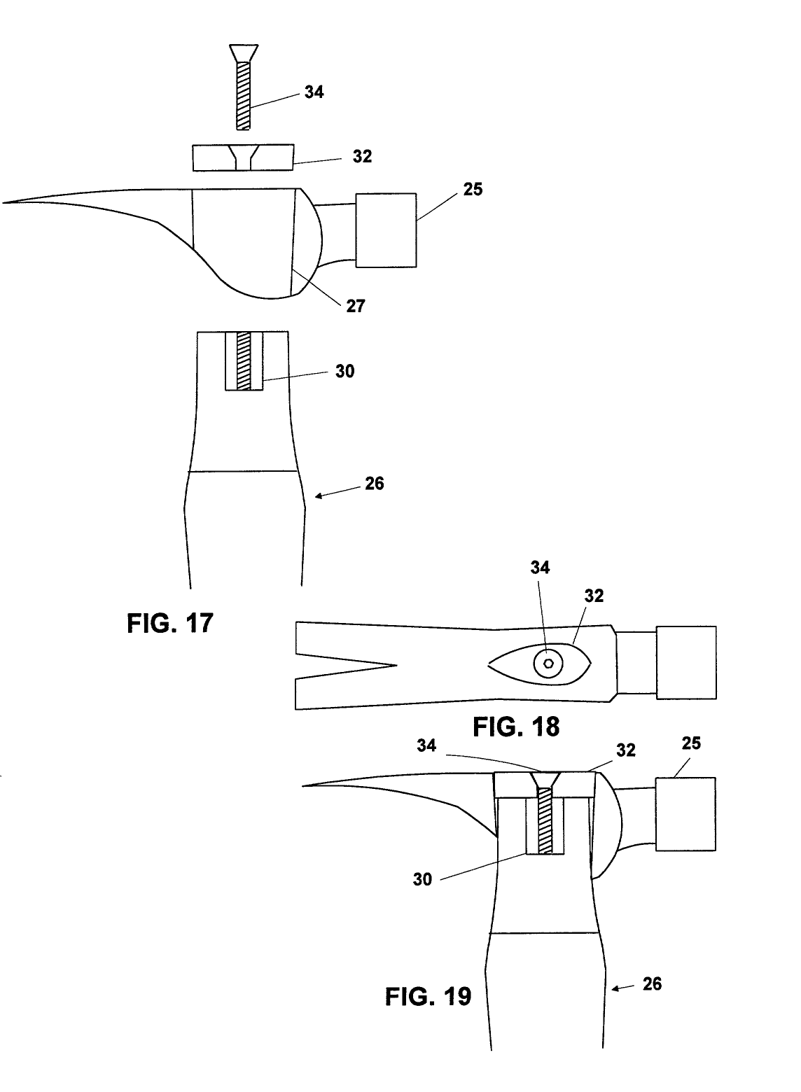

In the first preferred embodiment, head 25 is bolted to handle 26, as shown in FIGS. 17-19. Rectangular cuts are made as shown in formed handle sides 8A and 8B and in rib piece 2 to accommodate inserted nut 30, as shown in FIG. 15. Nut 30 is then welded to handle 26 as shown in FIG. 16.

FIG. 17 shows a side exploded view, FIG. 18 shows a top view, and FIG. 19 shows a side view of the second preferred embodiment. Conventional hammer head 25 with contoured opening 27 is lowered onto handle 26. Washer 32 is then inserted inside the top of opening 27 and hex bolt 34 is threaded onto nut 30 and tightened.

There are several advantages to the first preferred embodiment. One advantage is that it is much quicker to bolt hammer head 25 to handle 26 than it would be to glue it. Another advantage is that if damage is done to handle 26 or head 25, the head could be easily unbolted and the damaged part could be replaced without having to replace the entire hammer. Another advantage is that a user of the hammer can have a hammer kit that encompasses a variety of handle shapes and designs and head shapes and designs that can be interchanged with each other to create a custom tool to fit the user's need at any given moment.

### Gluing the Head

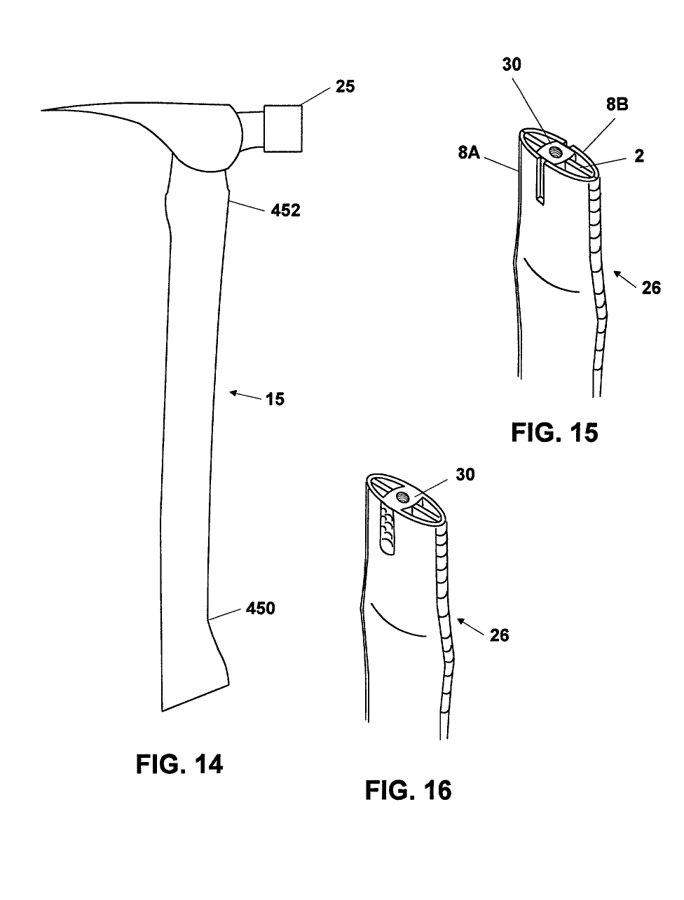

In the second preferred embodiment, head 25 is glued to the top of handle 15 as shown in FIG. 14. Although gluing the head is a fairly simple process, it is somewhat time consuming. It takes a worker approximately 15 minutes to complete the gluing process. Another disadvantage of gluing is that once head 25 is glued to handle 15, it is extremely difficult to remove it. Therefore, if there is damage done to either head 25 or handle 15, the entire hammer needs to be replaced.

### Third Preferred Embodiment

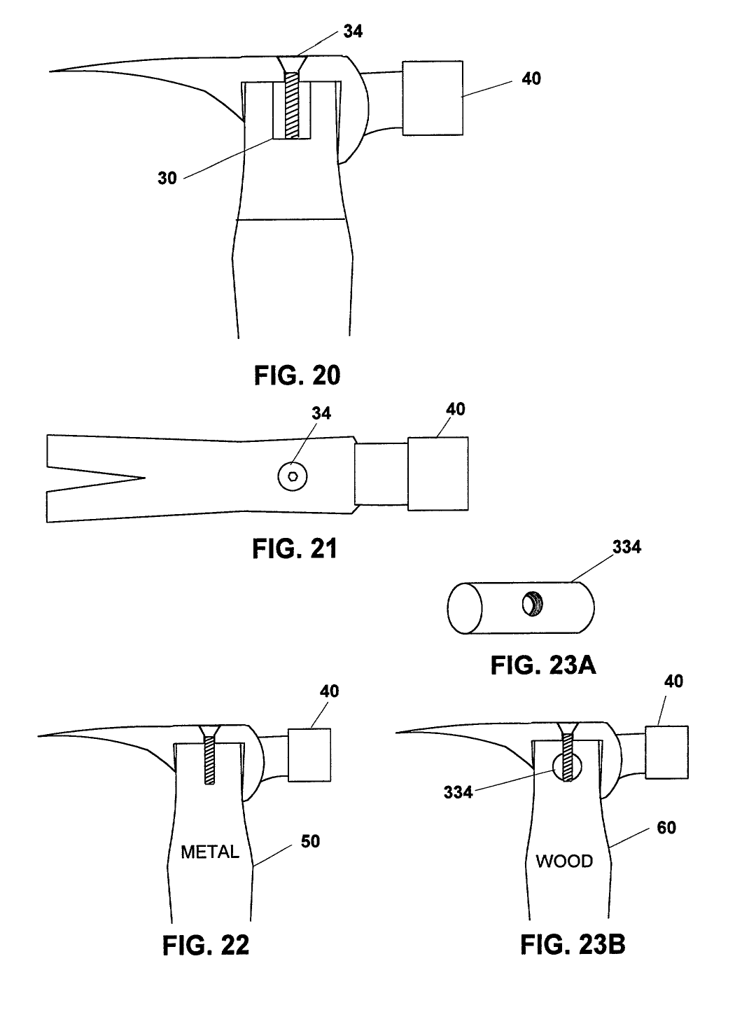

A third preferred embodiment is shown in FIGS. 20 and 21. In the third preferred embodiment, head 40 is cut so that the utilization of washer 32 (FIGS. 17-19) is unnecessary. There is a small hole in the top of head 40 through which bolt 34 is inserted. Bolt 34 is then threaded through nut 30 and tightened as described above.

### Fourth Preferred Embodiment

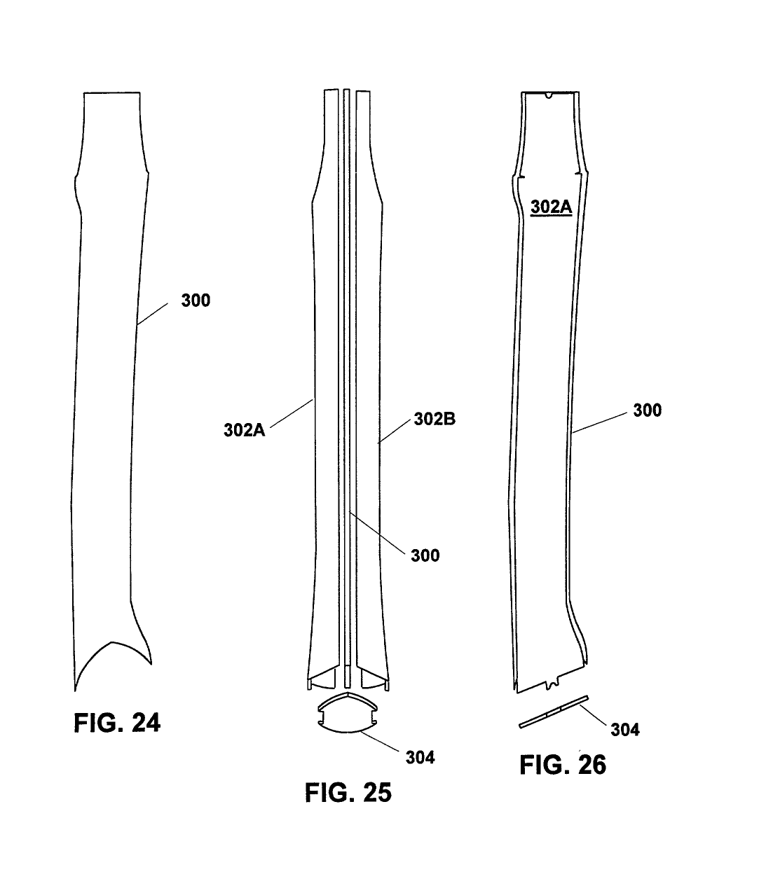

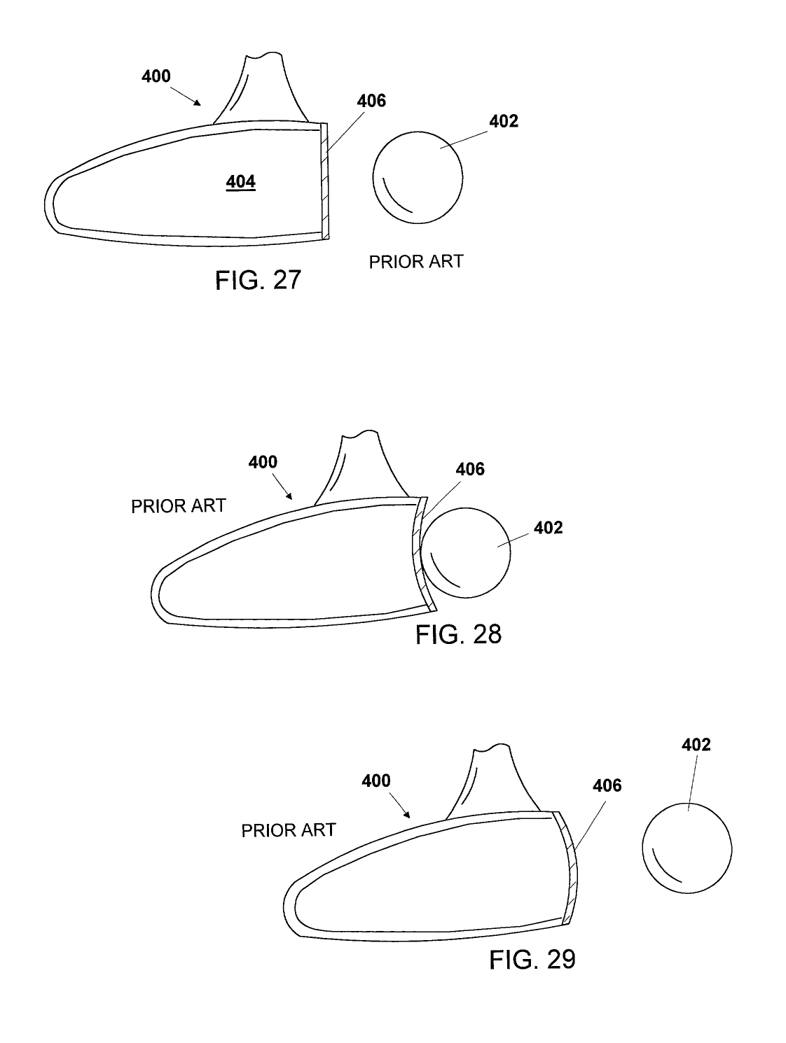

In the fourth preferred embodiment shown in FIG. 24, rib piece 300 is much longer than rib piece 2 shown in FIG. 2. Rib piece 300 is approximately the same length as formed handle sides 302A and 302B, as shown in FIG. 25. However, rib 300 does not need to be as thick as handle sides 302A and 302B. In the preferred embodiment, rib 300 is approximately 0.050 inches thick and handle sides 302A and 302B are approximately 0.063 inches thick. By making rib piece 300 the approximate length of formed handle sides 302A and 302B, rib piece 300 is able to absorb greater amounts of stress while the handle is being used. This makes the handle less likely to snap than the embodiment shown in FIGS. 10-11.

After rib piece 300 has been cut, it is aligned with formed handle sides 302A and 302B and handle bottom piece 304 as shown in FIG. 25. After alignment the pieces are clamped together. They are then tacked and welded together. In the preferred embodiment, rib piece 300 is cut so that its edges extend beyond formed handle sides 302A and 302B, as shown in FIG. 26. The edges of rib piece 300 serve as filler metal during the welding process.

### Varying Cross Section Area

By first cutting out handle sides, forming the handle sides into formed handle sides and then welding the formed handle sides together, a contoured handle having cross section areas that vary along the length of the handle can be made. Consequently stiffness can be added to the handle at areas subject to high stress and taken away from areas of the handle that are not subject to high stress. For example, as shown in FIG. 14, handle 15 is wider towards the top of the handle at section 452 than it is at the grip of handle at section 450. This is because the handle is subject to greater stress at section 452 than it is at section 450.

### Utilization of Rib

Also, in the preferred embodiments discussed above, a rib is used to provide extra stiffness to the handle. FIG. 10 shows a short rib 2 and FIG. 25 shows a long rib 300. Utilization of the rib contributes to the overall stiffness and strength of the handle. By utilizing a contoured hollow handle and adding a rib for support the strength and stiffness characteristics of the handle are optimized. Also, because the handle is made out of a low density material such as aluminum the handle is extremely lightweight. The density of aluminum is approximately 2.7 g/cm³. This contrasts sharply with steel that has a density of approximately 7.9 g/cm³. For example, the weight of Applicant's handle shown in FIGS. 10-13 is approximately 7 ounces.

### Hammer Head with Trampoline Plate

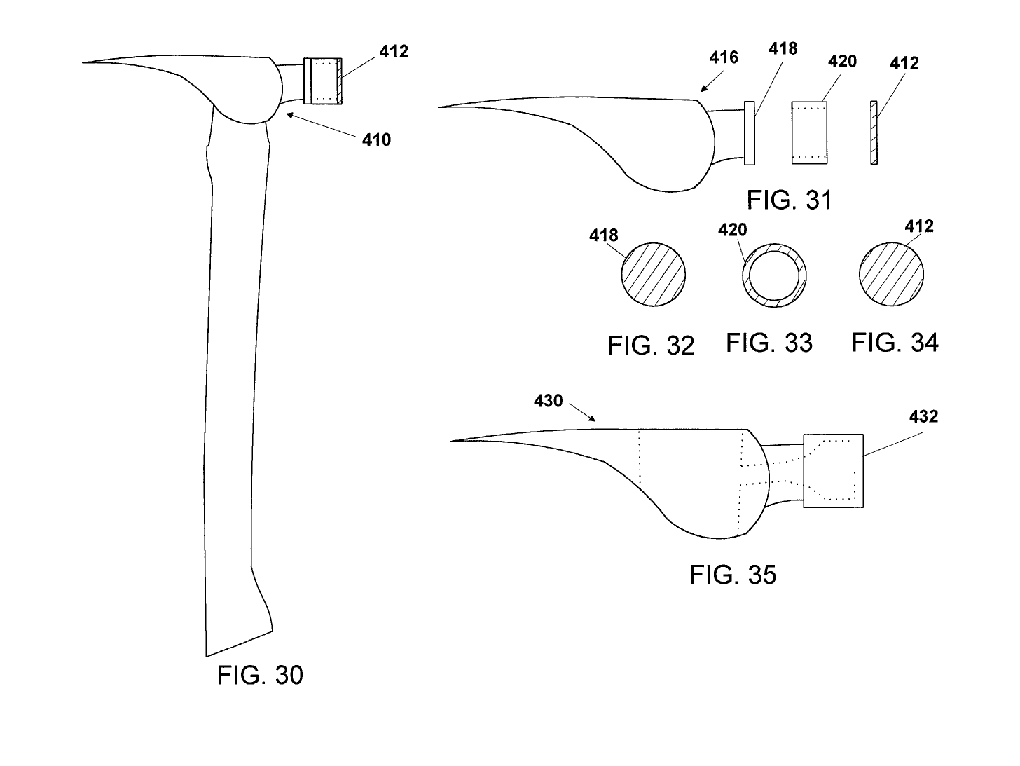

FIG. 30 shows a fifth preferred embodiment in which hammer head 410 has trampoline plate 412. Trampoline plate 412 deforms inward when it strikes a nail. Then, behaving like a spring, trampoline plate 412 rebounds outward, driving the nail with extra force.

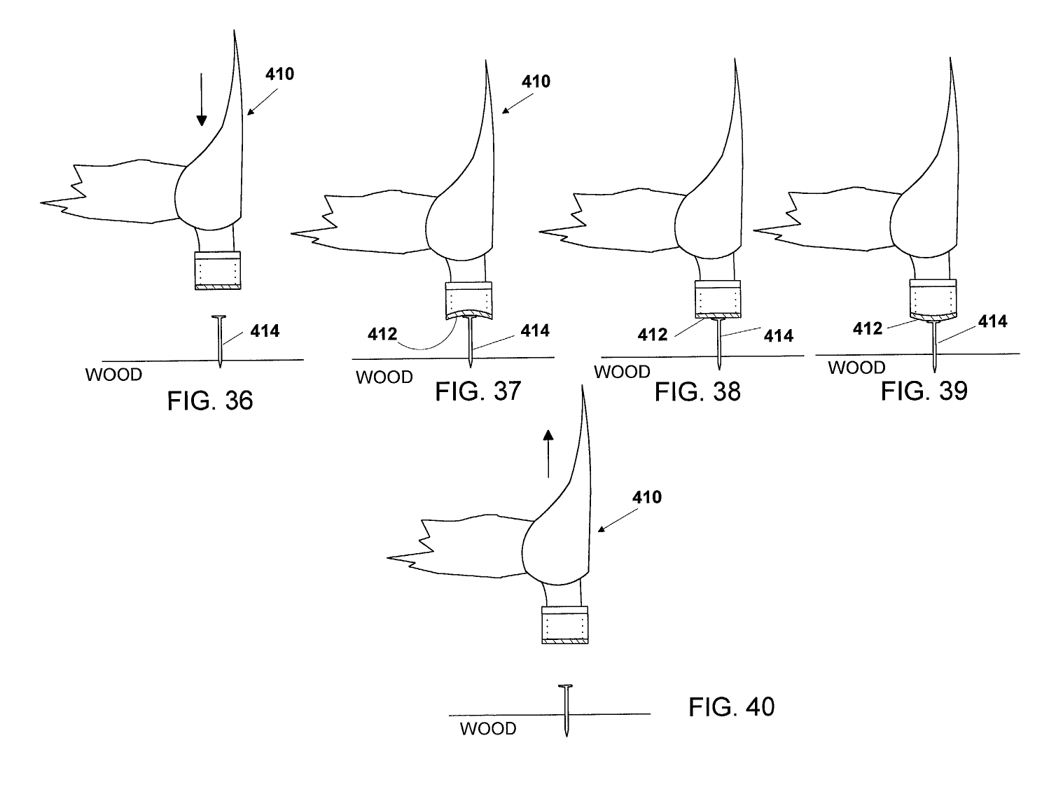

The operation of hammer head 410 is seen in more detail by referring to FIGS. 36-40.

In FIG. 36, hammer head 410 is being driven downwards towards nail 414, which is slightly imbedded in wood.

In FIG. 37, hammer head 410 has made contact with nail 414. The impact of hammer head 410 against nail 414 has caused trampoline plate 412 to deform inward. Nail 414 has been moved slightly further into the wood as a result of the impact.

In FIG. 38, behaving like a spring, trampoline plate 412 has partially rebounded. Consequently, nail 414 has been driven further into the wood.

In FIG. 39, trampoline plate 412 has fully rebounded and nail 414 has been driven even further into the wood.

In FIG. 40, hammer head 410 has been raised.

Preferably, the sequence illustrated in FIGS. 36-40 is repeated until the nail has been fully driven into the wood.

### Fabricating the Hammer Head

FIG. 31 shows an exploded view of hammer head 412. In the fifth preferred embodiment, hammer head 412 is fabricated from steel. Base section 416 has rounded support section 418 at its end. Preferably, hollow tube section 420 is welded to support section 418. Also, preferably trampoline plate 412 is welded to hollow tube section 420. In the preferred embodiment, trampoline plate 412 is approximately ⅛ inch thick. End views of support section 418, hollow tube section 420 and trampoline plate 412 are shown in FIGS. 32-34, respectively.

Alternatively, FIG. 35 shows a sixth preferred embodiment in which hammer head 430 has been cast from steel utilizing a mold to form trampoline plate 432.

### Trampoline Effect for the Hammer Head

The greater the trampoline effect, the greater the amount of energy that is transferred to the nail due to the trampoline effect. The trampoline effect is dependent upon the characteristics of the trampoline plate. For example, a thin trampoline plate will deform and rebound more than a thick trampoline plate. Higher deformation of the trampoline plate may also be achieved by modifying the material by which it is made. For example, high deformation can be achieved by fabricating the trampoline plate from a material having low stiffness and high strength, such as titanium.

### Effect of Hollow Hammer Head with Trampoline Plate

A hollow hammer head covered by a trampoline plate is a significant improvement over the prior art. Because the hammer head has a hollowed out section, it weights much less than a solid hammer head made of the same material. This results in a hammer that weights less and is therefore easier to operate and less fatiguing for the user. Also, the trampoline plate improves the efficiency of the hammer. When the hammer head strikes a nail, the trampoline plate deflects inward. Acting as a spring, energy is stored in the trampoline plate and then released when the trampoline plate rebounds. The release of this energy propels the nail forward with greater velocity into the medium into which it is being hammered.

### Handle Types

A hammer head having a trampoline plate can be used with a variety of handle types. For example, it can be used with a wood handle or a metal handle. Also, a hammer head having a trampoline plate can be utilized attached to the monocoque handles disclosed in the earlier preferred embodiments.

### Prototype

Applicant has actually built a prototype hammer head with trampoline plate similar to the embodiment shown in FIGS. 31-34. In the prototype, the trampoline plate was steel and was approximately ⅛ inch thick. Applicant, then tested the prototype by allowing 6 individuals to use the prototype to hammer a nail into a board. Each individual confirmed that the prototype hammer having a hammer head with trampoline plate was a substantial improvement over a conventional solid steel hammer head.

While the above description contains many specifications, the reader should not construe these as limitations on the scope of the invention, but merely as exemplifications of preferred embodiments thereof. Those skilled in the art will envision many other possible variations are within its scope. For example, although the above embodiments all showed the utilization of rib for extra strength and stiffness, it would be possible to make the present invention without a rib. For example, by making the skin of the handle thicker, its strength and stiffness would also increase. However, to achieve the same level of strength and stiffness that is achieved by the utilization of a rib, higher amounts of aluminum would need to be added to the skin thickness. Consequently a thick skinned handle without a rib would weight more than a thin skinned handle with a rib, assuming they both had the same strength and stiffness. Also, although the above preferred embodiments showed how a hammer head is bolted into a monocoque handle, it is possible to bolt a hammer head into other types of handles as well. For example, FIG. 22 shows head 40 bolted into solid metal handle 50. FIG. 23B shows head 40 bolted into threaded insert 334 (FIG. 23A) that has been tapped into the side of solid wood handle 60. Also, although it was stated in the first preferred embodiment that sheet 4 is 6061 aluminum and is approximately 0.063 inches thick, those of ordinary skill in the art will recognize that other sheet materials and/or other thicknesses could be used as well. For example, sheet 4 could be AZ31B magnesium. Magnesium is even less dense than aluminum (approximately 1.8 g/cm³), however it is also more expensive. Also, although all the above preferred embodiments disclosed a monocoque handle used in conjunction with a hammer head, it would also be possible to utilize the monocoque handle with other types of striking tools. Some of these tools include an ax, a pick-ax, and a mallet. Also, although it was disclosed that pieces are cut from sheet 4 using a water jet saw, it would also be possible to cut the pieces using other devices, such as a shearing dye, a laser or a band saw. Also, although it was disclosed how formed handle sides 8A and 8B are formed using a hydraulic ram press, it would also be possible to form the handle sides using other methods, such as utilizing a matched dye set. Also, although it was disclosed above that trampoline plate 412 is approximately ⅛ inch thick, the thickness could easily be modified. Thicker plates will be less likely to puncture, but they will not deform as much. Thinner plates will deform and rebound to a greater degree, but will be more likely to puncture. Also, the trampoline plate could be fabricated from a variety of materials other than steel and titanium as discussed above. Also, although the fifth preferred embodiment disclosed utilizing a hammer head having a trampoline plate, other striking tools besides a hammer can effectively utilize the trampoline plate. For example, a mallet could also include a mallet head that has a trampoline plate. Accordingly the reader is requested to determine the scope of the invention by the appended claims and their legal equivalents, and not by the examples which have been given.

I claim:

1. A striking tool, comprising:
A) a handle,
B) a head defining a front end and a back end, wherein said head is attached to said handle,
C) a trampoline plate attached to said head at said front end, said trampoline plate deflecting inward toward said back end and said trampoline plate rebounding in a direction away from said back end when said trampoline plate strikes an object.

2. The striking tool as in claim 1, wherein said striking tool is a hammer and said object is a nail.

3. The striking tool as in claim 1, wherein said head further defines a hollow portion at said front end, said hollow portion allowing for said inward deflection of said trampoline plate.

4. The striking tool as in claim 1, wherein said trampoline plate is steel and is approximately ⅛ inch thick.

5. The striking tool as in claim 1, wherein said trampoline plate is titanium.

6. The striking tool as in claim 1, wherein said head and said trampoline plate are cast from steel.

7. The striking tool as in claim 1, wherein said trampoline plate is welded to said head.

8. The striking tool as in claim 1, wherein said handle is wood.

9. The striking tool as in claim 1, wherein said handle is metal.

10. The striking tool as in claim 1, wherein said handle is a hollow handle.

11. The striking tool as in claim 10, further comprising a rib piece rigidly attached within said hollow handle.

12. The striking tool as in claim 11, wherein said rib piece and said handle have approximately equal length.

13. The striking tool as in claim 10, wherein said hollow handle comprises at least two formed handle sides rigidly attached to each other.

14. The striking tool as in claim 10, wherein said hollow handle comprises:
A) a first contoured handle half,
B) a second contoured handle half rigidly attached to said first contoured handle half, and
C) a handle bottom piece rigidly attached to the bottom of said hollow handle.

15. The striking tool as in claim 10, wherein said head is glued to said hollow handle.

16. The striking tool as in claim 10, wherein said head is bolted to said hollow handle.

17. The striking tool as in claim 10, wherein the hollow handle is aluminum.
